(19) United States
(12) Patent Application Publication
(10) Pub. No.: US 2010/0139424 A1
(43) Pub. Date: Jun. 10, 2010

(54) VIBRATOR FOR A GROUND COMPACTING APPARATUS

(75) Inventors: Stefan Wagner, Hunich (DE); Otto W. Stenzel, Herrsching (DE); Martin Awrath, Hunich (DE)

Correspondence Address: BOYLE FREDRICKSON S.C., 840 North Plankinton Avenue, MILWAUKEE, WI, 53203, US

(73) Assignee: Wacker Neuson SE, Munich (DE)

(21) Appl. No.: 12/596,043

(22) PCT Filed: Mar. 28, 2008
(86) PCT No.: PCT/EP2008/002501

§ 371 Date: Feb. 26, 2010

(30) Foreign Application Priority Data
Apr. 18, 2007 (DE) 10 2007 018 353.6

(51) Int. Cl. B06B 1/16; G01B 7/30

(52) U.S. Cl. 74/61; 324/207.25

(57) ABSTRACT

A vibrator for a ground compaction apparatus includes two parallel shafts which are coupled to one another be rotatable in opposite directions and on each of which is at least one unbalanced mass is disposed. A phase adjusting mechanism is used for modifying the phase angle of the two unbalanced masses relative to each other. In order to do so, the actual phase angle of the two unbalanced masses is detected with the help of proximity sensors or the like. A regulating device compares the actual phase angle with a desired phase angle that is predefined by the operator and controls the phase adjusting mechanism in such a way that the difference between the actual phase angle and the desired phase angle is minimal.

### BACKGROUND OF THE INVENTION

1. Field of the Invention

The present invention relates to a vibrator for ground compacting apparatuses, such as for vibrating rollers or vibrating plates.

2. Description of the Related Art

For vibrating rollers or plates, vibrators are known in which at least two shafts that are situated parallel to one another and that are positively coupled to one another, e.g. by gears, are capable of rotation in opposite directions. Each of these shafts bears at least one unbalanced mass; for steerable vibrating plates in particular, it is also possible to provide on a shaft a plurality of unbalanced masses that can be pivoted relative to the shaft bearing them with regard to their phase position.

The rotation of the shafts in opposite directions brings about a resultant force vector whose direction is determined by the phase position of the unbalanced masses rotating opposite one another. In order to enable modification of the phase position, a respective phase adjustment device is provided that adjusts the relative position of the unbalanced masses to one another. For example, it is known to provide a twisting or spiral sleeve in which a piston can be axially displaced. Through the axial displacement of the piston, and of a guide pin connected to the piston in a spiral groove of the twisting sleeve, the rotational position of the twisting sleeve changes relative to the shaft bearing it. If the twisting sleeve is in turn positively connected to an unbalanced mass, the relative position or phase position of this unbalanced mass then also changes relative to the rest of the system. In addition, other phase adjustment systems are suitable, such as modified differential or planetary drives.

In this way, the phase position of the two shafts, and thus of the associated imbalanced masses, can also be adjusted relative to one another; this has long been known in the prior art. Depending on the direction of the resultant force vector, the vibrating plate moves in the forward or backward direction, or operates in stationary vibrating mode.

If, moreover, two unbalanced masses are situated on the same shaft, axially offset from one another, and in addition a phase adjustment device is provided for adjusting the phase position of these unbalanced masses, a yaw moment can be produced about the vertical axis of the vibrator, and thus of the vibrating plate, in order to steer the vibrator. This is also known from the prior art.

As explained above, the phase adjustment device can have a twisting sleeve and an axially displaceable set piston [or: actuating piston] that specifies the rotational position of the twisting sleeve relative to the shaft under the action of a hydraulic system. The adjustment of the relative position and thus of the phase position of the unbalanced masses is realized in the form of a control unit. Via an operating element, the operator specifies a desire, e.g. forward or backward travel. This command is converted by the system into a particular position of the set piston, which is correspondingly controlled by the hydraulic system. A monitoring as to whether the unbalanced masses actually assume the specified relative position to one another does not take place. The operator learns the results of his control measures only by observing the modified travel behavior of the vibrating plate.

This means that the real, actually resulting vector angle of the resultant exciting force is not measured. In some circumstances, there can be significant deviations between the vector angle desired by the operator and the vector angle that is actually set. These deviations are caused by, for example, temperature effects (the hydraulic oil heats up, so that the hydraulic volume changes and the piston does not assume the planned position), or effects of wear. Soil contact forces can also cause strong deviations in the vector angle.

In pressure-guided systems not having a piston position measurement system, the position of the piston is determined only indirectly, and the angular position of the unbalanced masses is inferred therefrom. If there is significant play between the unbalanced masses, significant deviations can result in the resultant exciting force vector.

### OBJECT OF THE INVENTION

The present invention is based on the object of realizing, in the simplest way possible, a continuous adjustment with great precision of an exciting force vector. In this way, it is intended to be possible to set, for example, a forward or reverse travel speed of a vibrating plate in such a way that slow forward travel is possible with a large exciter force amplitude in the vertical direction (i.e., in the direction of the soil). The present invention is also intended to enable curved travel with any curve radii, with the use of a plurality of exciter modules situated around the center of gravity.

According to the present invention, this object is achieved by a vibrator as recited in Claim 1. Advantageous constructions of the present invention are defined in the dependent claims.

A vibrator according to the present invention has at least two shafts that are coupled so as to be capable of rotation in opposite directions, on each of which there is situated at least one unbalanced mass, as well as a phase adjustment device for modifying the phase position of the two unbalanced masses relative to one another, a phase position determination device for determining an actual phase position (actual value of the phase position) of the two unbalanced masses to one another, a control device for specifying a target phase position (target value of the phase position) of the unbalanced masses, and a regulating device for comparing the actual phase position with the specified target phase position and for controlling the phase adjustment device in such a way that a deviation between the actual phase position and the target phase position is minimal.

The shafts can be situated parallel to one another or at an angle to one another.

With the aid of the phase position determination device, it is possible to directly measure the position, or phase position, of the respective unbalanced masses relative to one another. The regulating device compares the actual phase position, determined in this way, of the unbalanced masses with a target phase position specified by the control device, and introduces corresponding regulating measures by controlling the phase adjustment device. Here, the phase adjustment device can be realized in a known manner, and can have for example a piston-cylinder unit in which the piston is hydraulically moved.

Through the direct acquisition of the phase position of the unbalanced masses, all disturbing influences are excluded, enabling a very precise regulation and thus controlling of the vibrator. Correspondingly, a vibrating plate or vibrating roller equipped with the vibrator can be guided, i.e. can be driven forward and backward at the suitable speed and steered, very precisely and with greater sensitivity.

The phase position determination device can have a position acquisition device for acquiring a rotational position of each of the unbalanced masses, the phase position determination device being capable of determining the actual phase position from the rotational positions of the respective unbalanced masses. The position acquisition device can be fashioned in such a way that the rotational position of a respective unbalanced mass is capable of being acquired at least at a position and/or at a time during a rotation of the unbalanced mass.

With the aid of the position acquisition device, it is thus possible to determine the position of the unbalanced mass at least once during a rotation of the unbalanced mass or shaft. At the same time, the point in time is also acquired at which the unbalanced mass assumes the relevant position. In this way, it is possible to determine, at a particular point in time, the position at which the rotating unbalanced mass is situated at that time. It is also possible to determine that the unbalanced mass is at a particular position during a rotation while determining the precise point in time.

From this information, the positions of the individual unbalanced masses can be precisely determined and placed into relationship with each other, so that as a result the phase position of the unbalanced masses to one another can be determined. A regulated adjustment of the phase position or of the phase angle of the shafts or of the unbalanced masses, and thus of the resulting unbalanced forces, can then be carried out based on this actually measured phase angle.

The rotational speeds of the exciter shafts of the vibrator fluctuate due to energy exchange processes between the exciter shafts and the rest of the system. Therefore, it is always possible to determine only an averaged phase angle or an averaged phase position through the temporal and/or local discretization of the measurement values of the positions of the unbalanced masses. The time interval over which the averaging takes place, as well as the actual deviation of the phase angle from this average value, is a direct function of the temporal/local discretization.

The position acquisition device can have at least two vicinity sensors that are each situated in the vicinity of a path of movement of a respectively allocated unbalanced mass, and that acquire an approach of the allocated unbalanced mass. With the aid of the sensors, it is particularly easy to recognize the presence of an unbalanced mass at a predetermined position. At the same time, the point in time is determined at which the unbalanced mass is situated in the vicinity of the proximity sensor. Here it is possible for example to detect the approach of the unbalanced mass to the sensor, or also the moving of the unbalanced mass away from the sensor after the unbalanced mass has passed by the sensor, in order to increase the measurement precision.

With the aid of the proximity sensors, the points in time can be acquired at which the respective unbalanced masses that are to be detected pass by the proximity sensors. From the speed of repetition, the period duration (T) is determined as the reciprocal of the rotational speed. From the time difference between the individual shafts (ΔT), it is then possible to determine the phase difference, taking into account the measurement positions, i.e. the position of the proximity sensors relative to the respective shaft (φ_{Position}) and the period duration:

φ=φ_{Position}+(ΔT/T)

Alternatively, or in addition to the proximity sensors, the position acquisition device can also have an incremental encoder that, in the simplest realization, determines the position of the respective unbalanced mass at only one point. In a superior realization, it is also possible to determine the acquisition of the position with a higher resolution, i.e. several times during a rotation of the unbalanced mass. The incremental encoder can also be fashioned so that it continuously acquires the position of the unbalanced mass.

Thus, the incremental encoder can have for example an additional small wheel that is seated on the shaft bearing the unbalanced mass, and whose rotational movement is acquired digitally or in analog fashion, e.g. using photodiodes. It is also possible to provide an optical pattern on the unbalanced mass or on the shaft that is acquired and evaluated by an optical device. In addition, a gear can be provided that rotates with the unbalanced mass and whose intermediate spaces are scanned optically, inductively, or capacitively.

With the aid of the position acquisition device, the rotational speed of the shafts and thus of the unbalanced masses can also be determined. If, for example using the above-named proximity sensors, the presence of a respective unbalanced mass in the vicinity of the proximity sensor is acquired during a rotation, the rotational speed can be precisely determined on the basis of the time that the unbalanced mass requires for a further rotation. Here, it can also make sense to evaluate not only the presence but for example also already the approach of the unbalanced mass to the proximity sensor as a criterion, which is expressed for example in the form of a signal rise and a corresponding signal edge.

The position acquisition device can be fashioned in such a way that the rotational position of a respective unbalanced mass is capable of being acquired indirectly by determining the position of an element that is coupled positively to the unbalanced mass. In this case, the position of the unbalanced mass is not determined directly; rather, the position of a “substitute” element is determined that is coupled to the unbalanced mass in such a way that the position of the substitute element changes precisely along with the position of the respective unbalanced mass.

For example, the phase adjustment device can have a piston that can be moved mechanically, hydraulically, and/or electrically, and can have a twisting sleeve that is capable of being rotated with a positive fit by a movement of the piston. The twisting sleeve can be positively coupled to at least one of the unbalanced masses and/or one of the shafts; here, the positively coupled element that is relevant for the acquisition of the position of the unbalanced mass is the piston or the twisting sleeve.

Due to the positive coupling of the unbalanced mass to the twisting sleeve and to the piston that displaces the twisting sleeve, every change in the phase position of the unbalanced mass must also entail a corresponding change in the position of the twisting sleeve or of the piston. Thus, the change in position of the twisting sleeve or of the piston can also be used as a precise criterion for the phase position of the unbalanced mass.

Between the position acquisition device and the rest of the phase position determination device, and/or between the phase position determination device and the regulation device, a data transmission link can be provided that has a data transmission path via cable or radio. In this way, it is possible to provide only the position acquisition device, i.e. for example the sensors or other recording devices, directly in the area of the unbalanced masses, while other, in particular vibration-sensitive, components of the phase position determination device, but also the regulation device and the control device, can be situated at a distance from the unbalanced masses. For example, in a vibrating plate these components can be situated on an upper mass that is decoupled in terms of vibration from the vibrator.

The control device can have an operating element that can be handled by an operator, for inputting a desired direction of travel. The control device can then be fashioned in such a way that it determines a suitable target phase position for the relevant unbalanced masses on the basis of the desired direction of travel. The target phase position is then used by the regulating device as a specification according to which the actual phase position is to be corrected.

As an operating element, for example an operating lever present on a drawbar of a vibrating plate is suitable. However, it is also possible to provide a remote control (infrared, radio, cable) via which the operator inputs the desired directions of travel. In addition to commands for forward and backward travel, the operator can also specify steering commands.

The control device can have a target device for specifying the target phase position as a function of target paths, target compactions, and/or target speeds. These targets can be specified by the operator, but also by a navigation system or by a control program.

Due to the fact that the vibrator according to the present invention makes it possible to preselect the position of the unbalanced masses with a very high degree of precision and then also to hold this position constant, continuously adjustable phase angles of the resultant vibration vector can be realized. In this way, e.g. a vibrating plate can be controlled with a high degree of sensitivity. For example, it is possible to achieve a gentle acceleration of the vibrating plate in a particular direction. Curved paths having curves of different sizes are also possible. For a steerable vibrating plate, it may be required to divide the unbalanced masses axially on at least one of the unbalanced shafts, and to enable them to be adjusted relative to one another with regard to their phase position.

In the following, the present invention is explained in more detail on the basis of examples with reference to the accompanying Figures.

### BRIEF DESCRIPTION OF THE DRAWINGS

FIG. 1 shows a schematic side view of a vibrating plate having a vibrator according to the present invention.

FIG. 2 shows the vibrator in a schematic top view;

FIG. 3 shows a relation between the phase position of the unbalanced masses and the resultant force vector;

FIG. 4 shows the relation between phase position and force vector for a different phase position of the unbalanced masses;

FIG. 5 shows a block diagram of the design of the control/regulation apparatus; and

FIG. 6 shows a position acquisition device in a schematic representation.

### DETAILED DESCRIPTION OF THE PREFERRED EMBODIMENT

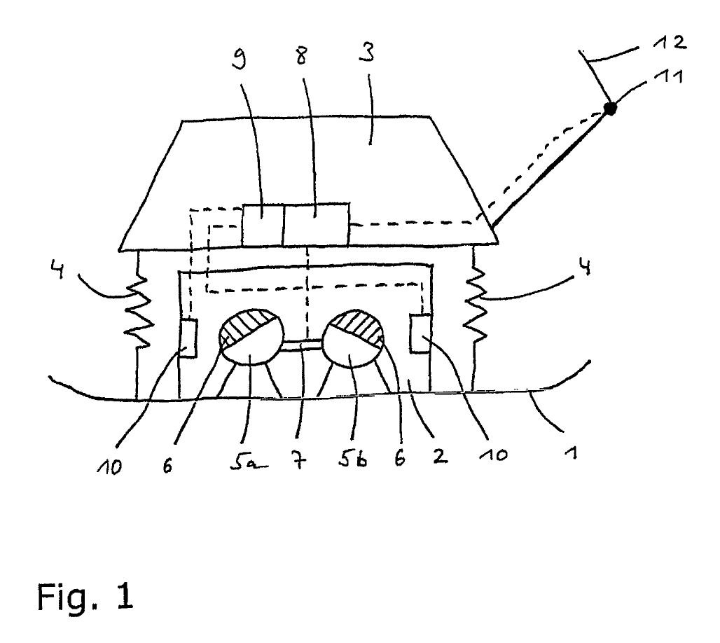

FIG. 1 shows, in a schematic view, an example of a design of a vibrating plate having a vibrator according to the present invention. The vibrator can also be installed in a vibrating roller for soil compaction.

The vibrating plate has a soil contact plate 1 for compacting soil. A vibrator 2 is situated on soil contact plate 1. Soil contact plate 1 and vibrator 2 together form a lower mass. Over the lower mass, there is situated an upper mass 3 that, inter alia, has in a known manner a drive (not shown) for vibrator 2. Upper mass 3 is decoupled in terms of vibration from the lower mass, in particular from soil contact plate 1, via spring-damper elements 4, so that soil contact plate 1 is movable relative to upper mass 3.

Vibrator 2 has two shafts 5a, 5b that are situated parallel to one another and that are coupled so as to be capable of rotation in opposite directions. The positive coupling of shafts 5a, 5b can be achieved for example with the aid of gears that mesh with one another. Each of shafts 5a, 5b bears at least one unbalanced mass 6 (or, 6a and 6b). Through the rotation of shafts 5a, 5b in opposite directions, there arises, due to the unbalanced action of unbalanced masses 6, a resultant force vector whose direction is a function of the phase position of unbalanced masses 6 relative to one another. This relation has already been explained in DE 100 53 446 A1.

In order to change the phase position of unbalanced masses 6, a phase adjustment device 7 is provided that is shown only schematically in FIG. 1.

On upper mass 3, a regulating device 8 is provided that controls phase adjustment device 7, and with which the phase position of unbalanced masses 6 can be set as a function of a direction of travel desired by an operator.

For this purpose, a phase position determination device 9 is provided for the determination of the actual phase position of the two unbalanced masses to one another. Phase position determination device 9 has two proximity sensors 10, which act as a position acquisition device, that are attached to the lower mass in vibrator 2 in the vicinity of the path of movement of rotating unbalanced masses 6, as is further explained below. Proximity sensors 10 are used to acquire the position of each of the unbalanced masses 6 in order to enable the phase position of the resultant exciting force vector to be derived therefrom. Instead of the movements of the unbalanced masses, it is also possible to acquire the rotational movements of substitute elements (e.g. markings) that rotate for example along with unbalanced shafts 5a, 5b.

The signals of proximity sensors 10 are evaluated by phase position determination device 9 and are supplied to regulating device 8 as information concerning the actual phase position of the two unbalanced masses 6.

In addition, a control device 11 is provided for specifying a target phase position for unbalanced masses 6. Control device 11 can for example have an operating lever 12 with which the operator can communicate a desired direction of travel in a conventional manner. It is also possible to provide a remote control with which the operator can communicate control data to the vibrating plate via cable, infrared, or radio. The operator's desire is “translated” by control device 11, or regulating device 8, into a suitable target phase position that is used as a target value for regulating device 8.

On the basis of a comparison of the target phase position and the actual phase position, regulating device 8 controls phase adjustment device 7 in such a way that the actual phase position comes as close as possible to the target phase position. In this way, a very sensitive controlling of the speed and direction of the vibrating plate is possible.

The signal lines are shown as broken lines in FIG. 1.

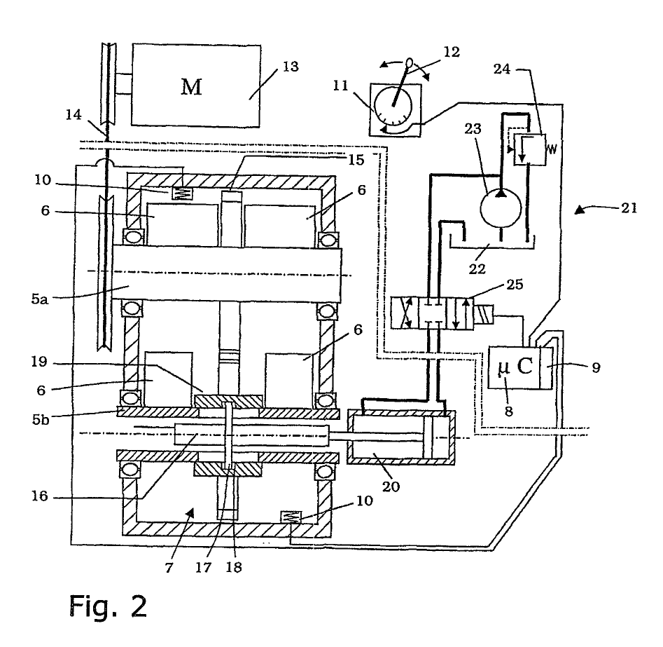

FIG. 2 shows the functional design of vibrator 2 and of the further elements of the vibrating plate in a schematic detail view. Components identical to those in FIG. 1 are designated with the same reference characters.

A drive motor 13 belonging to upper mass 3 drives a first unbalanced shaft 5a rotationally via a belt drive 14. The rotational movement of first unbalanced shaft 5a is transmitted via a gear coupling 15 to a second unbalanced shaft 5b, so that second unbalanced shaft 5b rotates with the same rotational speed as first unbalanced shaft 5a, but in the opposite direction. Each of the unbalanced shafts 5a, 5b bears two unbalanced masses 6. In the depicted example, each of the unbalanced masses 6 is fixedly connected to the unbalanced shaft 5a, 5b that bears it. However, in other specific embodiments is possible for at least one of the unbalanced masses 6 to be capable of being pivoted relative to the unbalanced shaft 5a, 5b that bears it, in order to modify the phase position of this unbalanced mass 6 relative to the associated unbalanced shaft 5a, 5b.

Phase adjustment device 7 is provided in the flow of torque between first unbalanced shaft 5a and second unbalanced shaft 5b, in the area of gear coupling 15. In a known manner, phase adjustment device 7 has, situated in unbalanced shaft 5b (which has a hollow construction), an axially movable set piston 16 that bears a transverse pin 17.

Transverse pin 17 is capable of being displaced in a spiral groove 18 of a twisting sleeve 19. If set piston 16 with transverse pin 17 is axially moved, twisting sleeve 19 must follow this movement by rotating relative to second unbalanced shaft 5b. Due to the supporting via gear coupling 15 relative to first unbalanced shaft 5a, the phase position is modified between the two unbalanced shafts 5a, 5b. Depending on the axial position of set piston 16, there thus results a particular phase position between unbalanced shafts 5a, 5b.

The axial positioning of set piston 16 is carried out by a piston-cylinder unit 20. Piston-cylinder unit 20 is connected to a hydraulic unit 21 having an oil reservoir 22, a hydraulic pump 23, and a pressure limiting valve 24. The controlling of the supplying and carrying off of oil takes place using an electrically actuatable valve 25, e.g. of a fluid flow control unit in the form of a 4/3-way valve having magnetic controlling.

Valve 25 is controlled by regulating device 8.

As described above, regulating device 8 receives, from control device 11 and from e.g. operating lever 12, control commands that are regarded as a signal for a target phase position.

In addition, proximity sensors 10 are provided inside vibrator 2 that detect, at least two positions, an approach of a respectively allocated unbalanced mass 6 during the rotation thereof. This proximity signal is also supplied to regulating device 8, or to phase position determination device 9 provided there, so that regulating device 8 can control valve 25 in a suitable manner in order to achieve the required phase position.

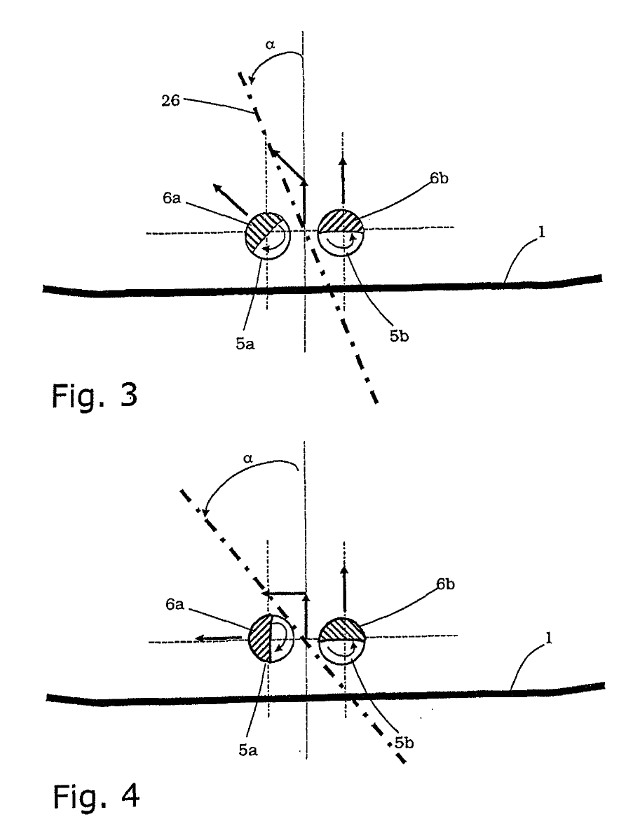

FIG. 3 schematically shows an example of a phase position of two unbalanced shafts 5a, 5b, or of the unbalanced masses 6a, 6b respectively borne by them. Unbalanced shaft 5a is regarded as the front unbalanced shaft, while unbalanced shaft 5b is the rear unbalanced shaft.

Due to the respective force action of unbalanced masses 6a, 6b during their rotation in opposite directions, a resultant exciting force vector arises whose direction is designated by reference character 26. Direction 26 can be determined by a vector angle α relative to the vertical. A vector angle of 0° thus corresponds to an exciting force that acts purely vertically, and indicates stationary vibration. Vector angle α of the exciting force is half of the phase angle between the two unbalanced masses 6a, 6b. A reduction of the phase angle between unbalanced masses 6a, 6b thus also results in a smaller vector angle α, and thus to a larger portion of the exciter force in the vertical direction and a smaller portion in the horizontal direction.

In FIG. 3, the phase angle is 45°, so that the vector angle α is, accordingly, 22.5°.

FIG. 4 shows the same system as FIG. 3, but with a phase angle of 90°, resulting in a vector angle α of 45°.

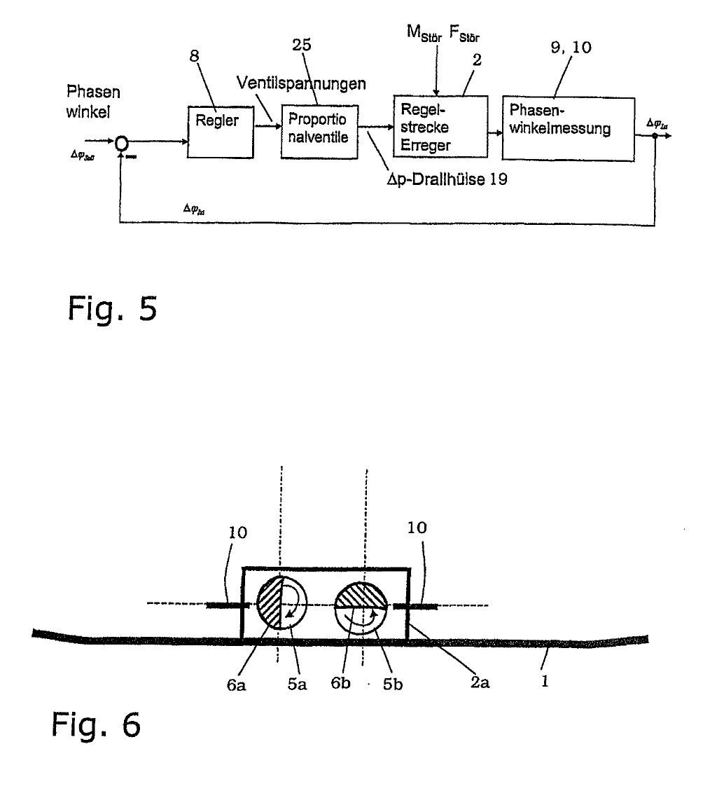

FIG. 5 schematically shows the design of the phase angle control circuit as was explained above on the basis of FIG. 2.

At the input of regulating device 8, the actual phase position and the target phase position are compared via the respective phase angle. Regulating device 8 then carries out, via valve 25, suitable control measures resulting in a rotation of twisting sleeve 19 and thus an adjustment of vibrator 2. The position of unbalanced masses 6a, 6b in vibrator 2 is determined with the aid of proximity sensors 10 and phase position determination device 9, which determines the actual phase angle.

A standard industrial regulator having an analog or digital design may be used as regulating device 8. Advantageously, regulating device 8 is situated on upper mass 3, because significantly lower mechanical stresses prevail there. The actually measured phase angle is provided to regulating device 8 by phase position determination device 9. Phase position determination device 9 can be provided directly on control device 8, but may also be provided at a different location on the vibrating plate.

The signal transmission to regulating device 8 takes place for example by means of cable, but may also take place by radio. Likewise, the signals outputted by proximity sensors 10 may be transmitted by cable or by radio to phase position determination device 9 or to regulating device 8. The control signals calculated by regulating device 8 (standardly the valve tension for the control valves, e.g. valve 25) are then in most cases transmitted to the valves via cable.

As explained above, for the measurement of the position of unbalanced masses 6a, 6b, proximity sensors 10, e.g. inductive digital proximity switches, may be used, as is also shown schematically in FIG. 6. For this purpose, for example a proximity sensor 10 is fastened in exciter housing 2a laterally for each shaft 5a, 5b that is to be monitored. Proximity sensors 10 may also be realized as Hall sensors or as capacitive sensors.

If the respective unbalanced mass 6a, 6b is situated below or in the vicinity of proximity sensor 10, proximity sensor 10 outputs a high level instead of a low level. On the basis of the change in the signal level, the point in time can then accordingly be recognized at which the beginning of an unbalanced mass 6a, 6b passes by in the direction of rotation; later, the point in time at which the end of unbalanced mass 6a, 6b passes by can likewise be recognized.

From the position of the proximity sensors relative to unbalanced masses 6a, 6b, the angle between unbalanced masses 6a, 6b at these two points in time can be determined. Because the unbalanced angles of the two unbalanced masses 6a, 6b are not determined at the same point in time, and the phase position of unbalanced masses 6a, 6b can and should change, e.g. supporting values of the angular position can be obtained for example by linear interpolation. For this purpose, the angular speed of the respective unbalanced shaft 5a, 5b for which the interpolation is to be carried out is required. The angular speed can thereupon be determined from two successive signal edges (rise or fall) and the elapsed time between them.

Instead of proximity sensors 10, for example incremental encoders may also be used to determine the position of unbalanced masses 6a, 6b.

1. A vibrator, comprising:
at least two mechanically coupled counter-rotating shafts, at least one unbalanced mass being situated in each shaft;
a phase adjustment device that selectively modifies the phase position of the two unbalanced masses relative to each other;
a phase position determination device that determines an actual phase position of the two unbalanced masses relative to each other;
a control device that specifies a target phase position of the unbalanced masses; and
a regulating device that compares the actual phase position with the specified target phase position, and that controls the phase adjustment device in such a way that a deviation between the actual phase position and the target phase position is minima, wherein:
the phase position determination device has a position acquisition device that acquires a respective rotational position of each of the unbalanced masses; and wherein
actual phase position of the two unbalanced masses is determined by the phase position determination device from the rotational positions of each of the unbalanced masses.

2. (canceled)

3. The vibrator as recited in claim 1, wherein the position acquisition device acquires the rotational position of each respective unbalanced mass at least one of a position and at a point in time during a rotational cycle of the unbalanced mass.

4. The vibrator as recited in claim 1, wherein, using the position acquisition device, the rotational position of each unbalanced mass is acquired by recognizing the presence of the respective unbalanced mass at a predetermined position.

5. The vibrator as recited in claim 1, wherein the position acquisition device has at least two proximity sensors that are each situated in the vicinity of a path of movement of a respectively allocated unbalanced mass, and that acquire an approach of the allocated unbalanced mass.

6. The vibrator as recited in claim 1, wherein the position acquisition device has an incremental encoder.

7. The vibrator as recited in claim 1, wherein the rotational speed of the shafts is determined by the position acquisition device.

8. The vibrator as recited in claim 1, wherein the position acquisition device indirectly determines the rotational position of a respective unbalanced mass by determining the position of an element that is coupled positively to the unbalanced mass.

9. The vibrator as recited in claim 8, wherein:
the phase adjustment device has a piston that is movable at least one of mechanically, hydraulically, and electrically, and a twisting sleeve that is capable of positive rotation through a movement of the piston;
the twisting sleeve is positively coupled to at least one of the unbalanced masses and to one of the shafts; and wherein
the positively coupled element that is relevant for the acquisition of the position of the unbalanced mass is one of the piston or the twisting sleeve.

10. The vibrator as recited in claim 1, wherein:
a data transmission link is provided at least one of i) between the position acquisition device and the rest of the phase position determination device, and ii) between the phase position determination device and the regulating device; and wherein
the data transmission link has a data transmission path via one of cable and radio.

11. The vibrator as recited in claim 1, wherein:
the control device has an operating element that can be handled by an operator for inputting a desired travel direction; and wherein
the control device determines a suitable target phase position on the basis of the desired travel direction.

12. The vibrator as recited in claim 1, wherein
the control device has a target device for specifying the target phase positions as a function at least one of target paths, target compactions, and target speeds.

13. A method of operating a vibrator that comprises at least two mechanically-linked counter-rotating shafts, at least one unbalanced mass mounted on each shaft, and a phase adjustment device, the method comprising:
determining an actual phase position of the two unbalanced masses relative to each other;
specifying a target phase position of the unbalanced masses;
comparing the actual phase position with the specified target phase position; and
controlling the phase adjustment device to minimize a deviation between the actual phase position and the target phase position.

14. The method as recited claim 13, further comprising acquiring a respective rotational position of each of the unbalanced masses, and wherein the actual phase position of the unbalanced masses is determined from the acquired rotational position of each of the unbalanced masses.

15. The method as recited in claim 14, wherein the rotational position of each unbalanced mass is acquired at least one of a position and at a point in time during a rotationally cycle of the unbalanced mass.

16. The method as recited in claim 15, wherein the rotational position of each unbalanced mass is acquired by recognizing the presence of the respective unbalanced mass at a predetermined rotational position.

17. The method as recited in claim 14, wherein the rotational position of each unbalanced mass is acquired indirectly by determining the position of an element that is coupled positively to the unbalanced mass.

18. The method as recited in claim 13, wherein the actual phase position determining step comprises
using signals from proximity sensors, determining the rotational period (T) through which each of the unbalanced masses rotates through a complete rotational cycle;
determining the difference (ΔT) between the periods (T) of the unbalanced masses;
taking into account the position of the proximity sensors relative to the respective shafts (φ_{Position}), determining the phase φ using the equation: φ=φ_{Position}+(ΔT/T).
